(19) United States
(12) Patent Application Publication
(10) Pub. No.: US 2011/0238481 A1
(43) Pub. Date: Sep. 29, 2011

(54) METHOD AND APPARATUS FOR DIGITAL DISTRIBUTION TO A MOBILE HANDSET

(75) Inventor: Daren Tsui, Palo Alto, CA (US)

(73) Assignee: MSPOT, INC., Palo Alto, CA (US)

(21) Appl. No.: 12/732,998

(22) Filed: Mar. 26, 2010

(51) Int. Cl. G06Q 30/00; G06Q 50/00; G06Q 20/00

(52) U.S. Cl. 705/14.35

(57) ABSTRACT

A method and apparatus for providing digital content to a mobile handset is provided.

### FIELD

The disclosure relates generally to a method and apparatus for providing digital content to a mobile handset.

### BACKGROUND

In recent years, mobile handsets (such as cellular phones, PDAs, iPhones® by Apple Computer®, and Nexus® devices by Google®) have become more powerful than prior generations of mobile handsets and now offer additional functionality beyond just voice communication. For instance, many mobile handsets today allow users to perform web browsing on the Internet, receive emails, and store and play video and audio content. Such devices contain increasingly powerful processors and enhanced video and audio capability. However, the storage capacity in mobile handsets typically still is smaller than the capacity of PCs and other types of computers. As a result, users of mobile handsets sometimes utilize digital content (such as video and audio content) that is streamed over a wireless or wired network rather than digital content that is downloaded and stored permanently. In addition, certain types of content licenses from movie and music studios prohibit the permanent storage of digital content on a user's device.

At the present time, content providers typically give mobile handset users the option of either paying for each piece of digital content that is streamed to the mobile handset (e.g., $1 per movie) or paying a fixed subscription fee to obtain digital content over a certain period of time (e.g., $10 per month for unlimited streams or for 5 movies).

In various contexts, consumers sometimes are provided with “credits” to apply to the use of services, where the credits will expire after a certain period of time. For example, many cell phone voice plans will provide a certain number of minutes of cell phone use per month for a given price. At the end of the month, any remaining minutes are deemed expired.

In another area, movie studios tightly control the release of their movies and other video content. For example, the lifecycle of a movie typically includes showing the movie in theaters, followed by a release of DVDs for sale, followed by video-on-demand in either a pay-per-view or subscription-based format, followed by cable TV and then network TV. These periods are mutually exclusive, meaning that a movie studio will not permit a movie to be shown on cable TV if it is still being offered in the video-on-demand phase of the lifecycle. In a pay-per view video-on-demand format, the user will pay a certain amount of money to watch the video content, and the movie studio typically will be paid a percentage of each transaction. In a subscription-based video-on-demand format, the user will pay a monthly subscription and will be allowed to watch videos from a specified library of video content as many times as desired over a certain time period, and the movie studios that creates the library of video content will each be paid a portion of the monthly subscription fee. It often can be a challenge to determine what portion should be paid to each studio, since there is no discrete transaction to measure or count for purposes of determining the appropriate royalty payment.

To date, service providers have not used credits as a form of payment for subscription-based video service for content in the initial DVD and video-on-demand windows, for online or mobile handsets. Using credits would have numerous advantages in that context.

### SUMMARY

A method and apparatus are provided to implement a credit system for the delivery of digital content to mobile handsets.

The embodiments of the system provide an efficient payment and billing system by using credits as a form of payment for digital content streamed to a mobile handset. For example, if a service provider wishes to raise all of its prices, it can simply increase the price for each credit (e.g., from $1 per credit to $1.25 per credit). Because each piece of content is already associated with a certain amount of credits (e.g., one movie for two credits), all of the prices for each piece of digital content will be raised automatically once the credit price is raised.

In addition, consumers often will be more willing to spend a credit on a service or good than they would be to spend actual money.

Credits also enable a content provider to create a reward system for mobile handset users. For example, in addition to providing credits in response to direct payments, a service provider can allow a mobile handset user to earn credits through other means, such as by participating in a survey or viewing or listening to an advertisement. Providing a user with credits will motivate him or her to use systems offered by the content provider.

Credits also represent a hybrid model that has a combination of characteristics of pay-per-view and subscription based services for obtaining and paying for video content from movie studios. For example, offering video-on-demand window content in exchange for a credit (which is not itself cash), where the user pays a monthly subscription to obtain a certain number of credits, but uses credits for discrete transactions (e.g., pay two credits to watch a given movie) is a hybrid model that may enable the content provider to obtain rights from movie studios to offer video-on-demand window content within the hybrid service. Since movie studios at times will combine the initial DVD sales window (before the video-on-demand window) with the video-on-demand window, the hybrid service may also include content within the DVD window. That type of format is a type of video-on-demand, but is neither fully subscription-based nor pay-per-view. Optionally, the credits can expire at the end of a certain time period, such as at the end of a month.

### BRIEF DESCRIPTION OF THE DRAWINGS

FIG. 1 is a depiction of an exemplary mobile handset.

FIG. 2 is a depiction of exemplary hardware components of a mobile handset.

FIG. 3 is a depiction of exemplary software components of a mobile handset.

FIG. 4 is a block diagram of an exemplary mobile handset device service system.

FIG. 5 is a block diagram of an exemplary billing server.

FIG. 6 is a depiction of exemplary database tables.

FIG. 7 is a depiction of an exemplary database table.

### DETAILED DESCRIPTION OF ONE OR MORE EMBODIMENTS

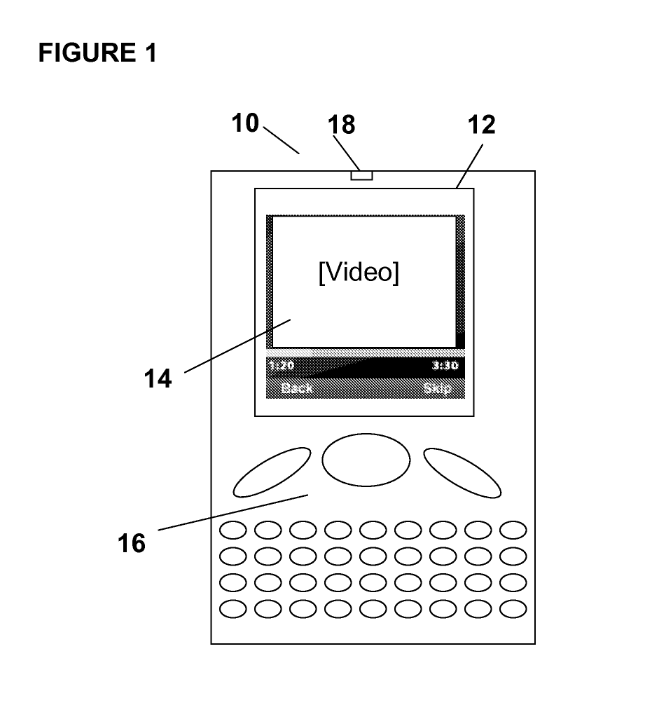

FIG. 1 depicts an exemplary mobile handset 10. In this example, mobile handset 10 includes a display 12, keypad or touchscreen 16, and speaker 18. Display 12 optionally can be a touchscreen itself, rendering a separate keypad or touchscreen 16 unnecessary. The display 12 can display still and moving video as well as text. The display 12 can display applications (such as a video player) in a window 14. Mobile handset 10 can be a PDA, mobile phone, Blackberry® by RIM®, iPhone® by Apple Computer®, Nexus® by Google®, or any other mobile computing device that is a processor based device with memory and wireless circuits for wireless connectivity with the mobile device service system 40 described below.

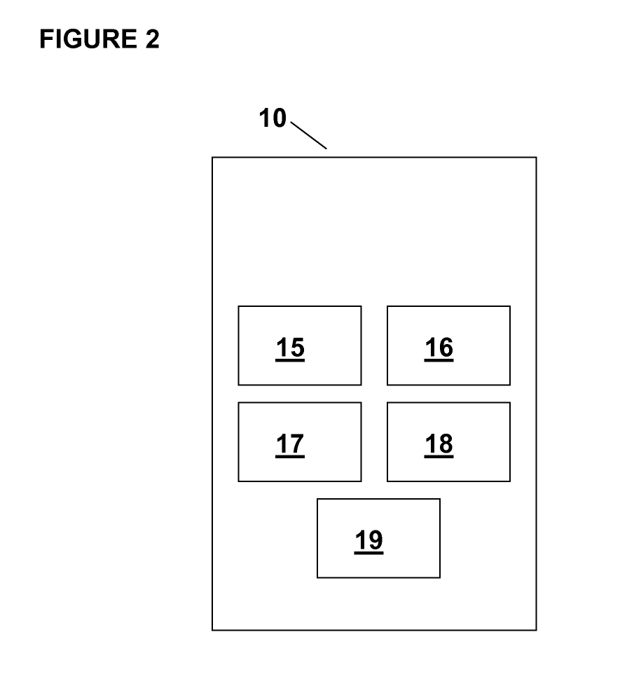

FIG. 2 depicts exemplary hardware components contained within exemplary mobile handset 10. In this example, mobile handset 10 includes a processing unit (such as a CPU) 15, memory 16 (such as RAM) for storing programs and instructions used by processing unit 15 and other components, a graphics controller 17 for controlling display 12, a transceiver 18 for engaging in wireless communication, and a non-volatile storage device 19 such as a hard disk drive, flash memory, or other storage. Processing unit 15, memory 16, graphics controller 17, transceiver 18, and non-volatile storage 19 optionally are mounted on a printed circuit board (not shown) and are electrically coupled to one another. Mobile handset 10 typically will contain other hardware components that are not shown.

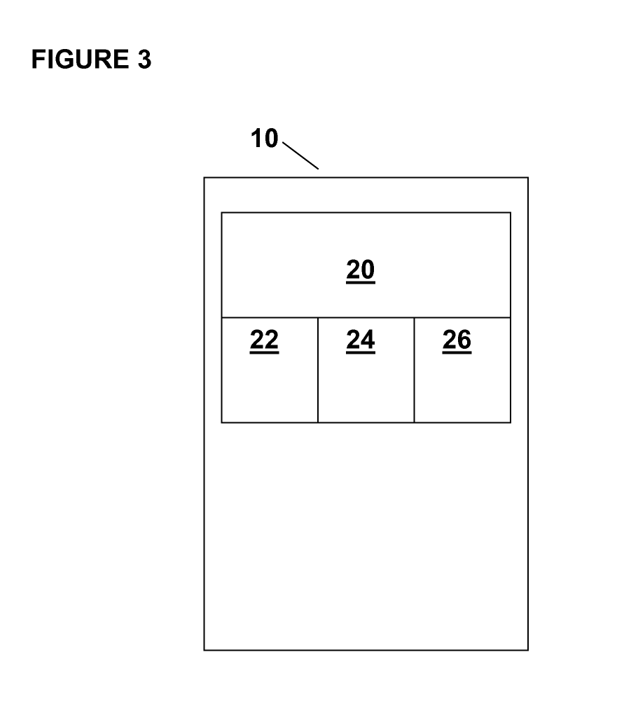

FIG. 3 depicts exemplary software components of exemplary mobile handset 10. In this example, mobile handset 10 optionally includes an operating system 20 (such as the Google® Android® operating system, the Apple® iPhone OS®, or the Palm® WebOS®) for controlling the hardware and software operations of mobile handset 10 as well as input/output devices such as keypad or touchscreen 16. Mobile handset 10 optionally includes a web browser 22 for providing Internet capabilities (such as Internet Explorer® by Microsoft®), one or more multimedia applications 24 for providing services such as playing video and audio content such as movies and music, and additional applications 26, which can be any type of application available for mobile handsets. These software components are merely illustrative.

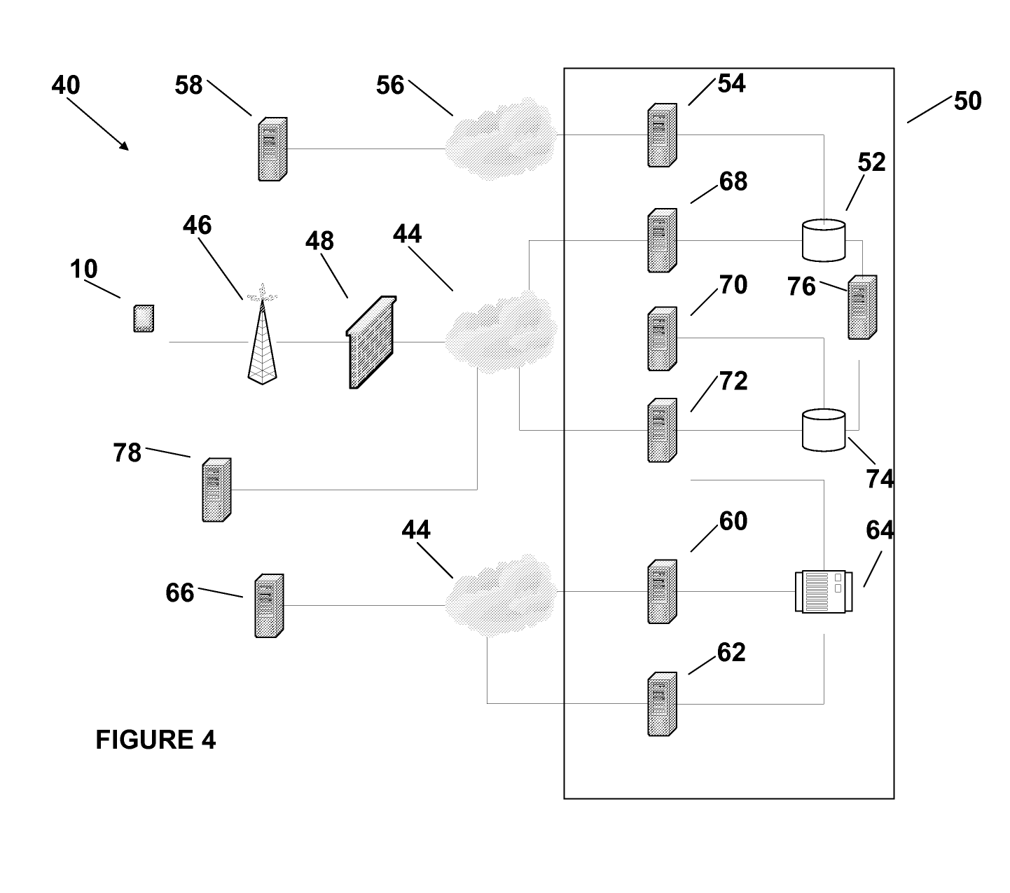

FIG. 4 depicts a typical mobile handset service system 40. The mobile device service system 40 provides one or more services, such as movies, videos, sports information, music, ringtones, social networking services, GPS applications, etc. to a mobile handset 10 that includes multimedia application 24 (not shown in FIG. 4) that processes the incoming service data and displays the service data to the user of the mobile device. In the example shown in FIG. 4, the mobile handset 10 couples to a communications link 44, such as the Internet, over a wireless network 46 and a firewall 48. The mobile handset service system 40 also has a service unit 50 that performs various functions and operations for the mobile handset service system.

The service unit 50 may include a user information storage unit 52 that stores information about each user of the mobile handset service system including user billing information and user service personalization information. The service unit 50 may also have a billing server 54 that performs a billing operation for the services provided to the user. In the example shown in FIG. 4, the billing for the services are communicated over a secure link 56, such as a secure socket layer (SSL) connection, to a carrier billing system 58 so that the mobile device carrier can provide the bill for the services on the monthly invoice of the user of the mobile device. Alternatively, the service unit 50 can directly bill the user. The service unit 50 may also include a live content ingester 60, a clip digester 62 and a content/asset storage unit 64 that handle the service content (such as music, movies, etc.) from a third party 66 that will be delivered by the mobile handset service system. The live content ingester receives any live content and processes it and then stores the live content in the content/asset storage unit 64 in various output encoding and file formats. The clip digester 62 receives non-live content and data, processes it and then stores the clips in the storage unit 64 in various output encoding and file formats.

The service unit 50 may further include a menu/personalization unit 68, a reporting unit 70, a streaming unit 72, a log database 74 and a data mining unit 76. The menu/personalization unit 68, the reporting unit 70, the streaming unit 72 and the data mining unit 76 may preferably each be server computers. The menu/personalization unit generates and delivers the mobile device service user interfaces to the user that may also be customized by the user based on the customization information stored in the user information storage unit 52. The streaming unit 72 may preferably support the real-time streaming protocol (RTSP) and the hypertext transfer protocol (HTTP) and may deliver/stream the service content to the mobile device over the link 44. The streaming unit 72 may request the service content from the content store 64 and may store service content information in the log store 74. The reporting unit 70 may generate a report about various aspects of the service unit and its operations. The data mining unit 76 collects user behavior information which is then mined to determine any recommendations and personalizations for users of the system.

A user of mobile handset 10 can run multimedia application 24 to listen to music, an audiobook or eBook, or other audio programming or to watch a movie, TV show, or other video content streamed from streaming unit 72. In one embodiment, streaming unit 72 will send the digital content to the mobile handset 10 and will also send metadata to the mobile handset 10. The metadata can include information such as the title of the song or video, the duration of the song or video, etc. The metadata also can include a URL for a website housed on third-party server 78 that offers products for sale that are relevant to the content being streamed to mobile handset 10. Examples of such products might include ringtones that contain the same music being streamed to mobile handset 10, CDs containing the same music, DVDs containing the video being streamed to mobile handset 10, etc.

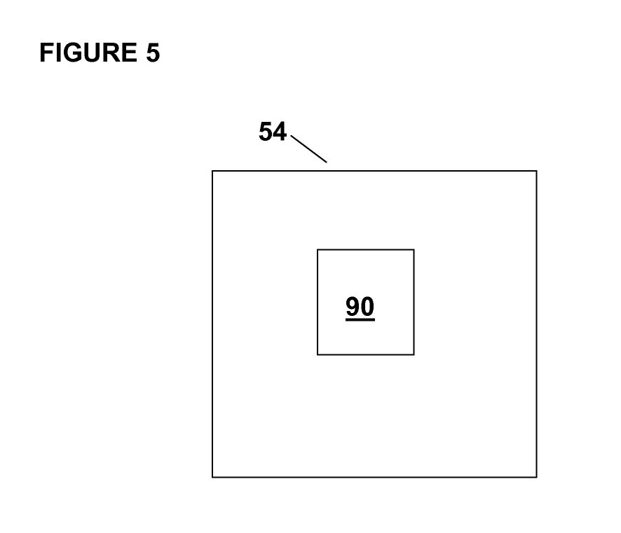

With reference to FIG. 5, billing server 54 is shown in greater detail. Billing server 54 includes credit database 90 implemented in software and/or hardware. Credit database 90 is used to implement, in part, the credit aspect of the embodiments. Billing server 54 optionally can be configured to provide an automatic payment to the copyright owner of particular video or audio content based on the number of times over a certain time period that the content was streamed to a user, which can be measured, among other ways, by counting the number of credits that were deducted in exchange for the streaming of that content over a certain time period (e.g., over a month).

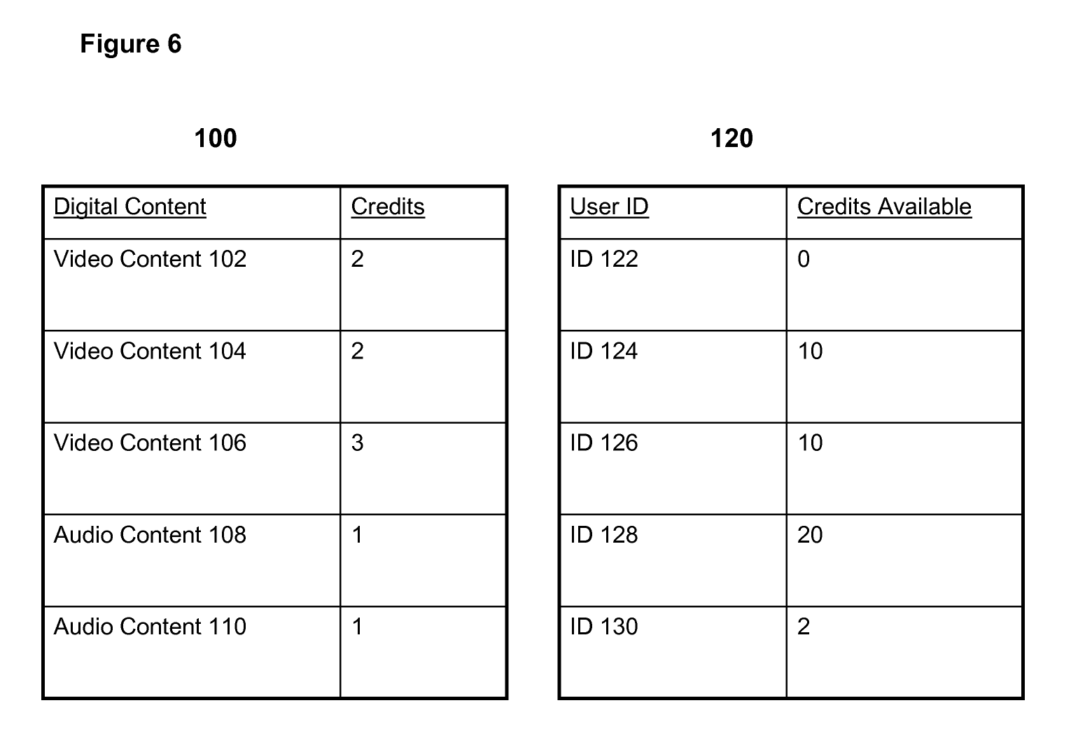

With reference to FIG. 6, exemplary tables in credit database 90 are shown. Credit database 90 includes table 100. Table 100 includes a mapping between the digital content available to mobile handsets such as mobile handset 10 and the pricing of such digital content in terms of credits. In the example shown, Table 100 includes data indicating that Video Content 102 requires 2 credits, Video Content 104 requires 2 credits, Video Content 106 requires 3 credits (perhaps because its licensing fee is greater than Movies A and B, it is longer in duration, or it is in higher demand by consumers), Audio Content 108 requires 1 credit, and Audio Content 110 requires 1 credit. Table 100 keeps track of the price of each piece of video and audio content in terms of credits.

Credit database 90 also includes table 120. Table 120 includes a mapping between mobile handset users and the number of credits that each user has been allocated. Each user has been assigned a unique User ID that is used to identify the user and track his or her activities. In the example shown, Table 120 includes data indicating that User ID 122 has 0 credits available, User ID 124 has 10 credits available, User ID 126 has 10 credits available, User ID 128 has 20 credits available, and User ID 130 has 2 credits available. User IDs 122-130 each corresponds uniquely to a mobile handset user. Table 120 keeps track of how many credits each user has in his or her account. A user can replenish his/her account by paying more (through a user interface of the billing server 54, for example) or can earn credits as described below.

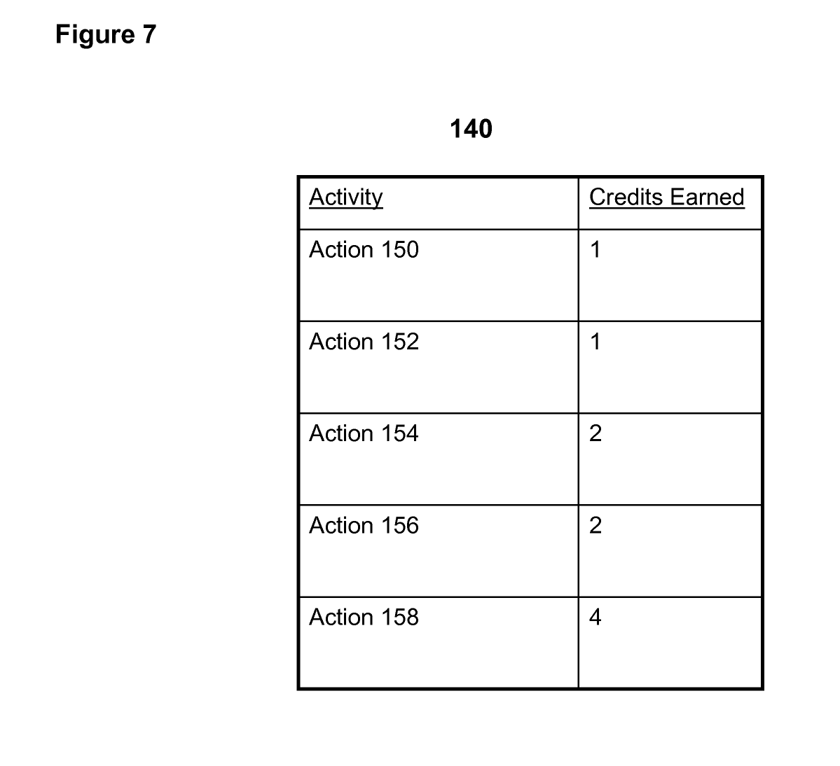

With reference to FIG. 7, another exemplary table in credit database 90 is shown. Table 140 includes a mapping between actions that enable a user to purchase or earn credits and the associated credits for each action. In the example shown, Table 140 includes data indicating that Action 150 earns a user 1 credit, Action 152 earns a user 1 credit, Action 154 earns a user 2 credits, Action 156 earns a user 2 credits, and Action 158 earns a user 4 credits. Action 150 could be, for example, a mobile handset user purchasing a credit for a certain sum, such as $1. By altering this row in the table, the operator of credit database 90 can quickly and efficiently change the price of purchasing a credit. For example, by changing the credit entry to 2, the price of each credit then would become $0.50, which would reduce the price of each piece of digital content in Table 100 by 50 percent. Similarly, by changing the credit entry to 0.5, the price of each credit then would become $2, which would increase the priced of each piece of digital content in Table 100 by 100 percent. Action 152 could be a user watching, viewing, and/or listening to an advertisement, Action 154 could be purchasing another service or product from the mobile service provider or other entity, Action 156 could be engaging in another mobile handset application (such as a social networking game), and Action 158 could be signing up for a service contract with the mobile service provider or other entity. These actions, of course, are exemplary and virtually any activity could be used as a basis for earning credits.

In one or more of these embodiments, a user of mobile handset 10 can initiate communication with service unit 50 to request digital content by using display 12 or keypad or touchscreen 16 in conjunction with a graphical user interface. That digital content can comprise audio content and/or video content, such as music, movies, ringtones, etc. Service unit 50 receives the request, and streaming unit 72 then streams the requested digital content to mobile handset 10. Mobile handset 10 then can play the digital content using display 12 and speakers. Table 120 is then adjusted to decrease the number of credits associated with the user of mobile handset 10 by the number of credits indicated as the price of the requested digital content in Table 100. The user of mobile handset 10 can replenish his or her account, by paying for additional credits or by performing actions to earn the credits according to the relationships established in Table 140.

Through these embodiments, a mobile service provider can provide a flexible pricing and billing system for digital content delivered to mobile handsets. The use of credits provides benefits not available in systems that solely use the exchange of money as the basis for obtaining digital content.

While the foregoing has been with reference to particular embodiments, it will be appreciated by those skilled in the art that changes in these embodiments may be made without departing from the principles and spirit of the invention, the scope of which is defined by the appended claims.

1. A method for providing digital content in exchange for credits, comprising the steps of:
providing one or more credits to a user of a mobile handset, wherein said credits will expire if not used within a predetermined time period;
receiving a request from said mobile handset for digital content over a network;
streaming said digital content to said mobile handset; and
reducing the number of credits allocated to said user in a database when said digital content is streamed to said mobile handset.

2. The method of claim 1, wherein the content comprises audio content.

3. The method of claim 1, wherein the content comprises video content.

4. The method of claim 1, wherein said mobile handset comprises a touchscreen that is used to initiate said request.

5. The method of claim 1, wherein said mobile handset comprises a keypad that is used to initiate said request.

6. The method of claim 1, further comprising playing said digital content on a display on said mobile handset.

7. The method of claim 6, further comprising adding one or more credits to an account associated with said user in said database.

8. The method of claim 7, wherein the adding step occurs in response to receiving an indication of a monetary payment.

9. The method of claim 7, wherein the adding step occurs in response to receiving an indication of an action taken by said user to earn said one or more credits.

10. A system for providing digital content in exchange for credits, comprising:
a database for providing one or more credits to a user of a mobile handset, wherein said credits will expire if not used within a predetermined time period;
a server for receiving a request from said mobile handset over a network for digital content and for streaming said digital content to said mobile handset;
said database configured to reduce the number of credits allocated to said user in a database.

11. The system of claim 10, wherein the content comprises audio content.

12. The system of claim 10, wherein the content comprises video content.

13. The system of claim 10, wherein said mobile handset comprises a touchscreen that is used to initiate said request.

14. The system of claim 10, wherein said mobile handset comprises a keypad that is used to initiate said request.

15. The system of claim 10, wherein said mobile handset is configured to play said digital content on a display.

16. The system of claim 15, wherein said database is further configured to add one or more credits to an account associated with said user.

17. The system of claim 16, wherein said server comprises a module for receiving an indication of a monetary payment.

18. The system of claim 16, wherein said server comprises a module for receiving an indication of an action taken by said user to earn said one or more credits.

19. A method for providing digital content in exchange for credits, comprising the steps of:
adding one or more credits to a database record associated with a user of a mobile handset, wherein said one or more credits will expire if not used within a predetermined time period;
receiving a request from said mobile handset for video content over a network;
streaming said video content to said mobile handset;
reducing the number of credits allocated to said user in said database when said video content is streamed to said mobile handset.

20. The method of claim 19, wherein said mobile handset comprises a touchscreen that is used to initiate said request.
